(19) United States
(12) Patent Application Publication
(10) Pub. No.: US 2023/0044072 A1
(43) Pub. Date: Feb. 9, 2023

(54) MONITORING SIDE CHANNELS

(71) Applicant: Hewlett-Packard Development Company, L.P., Spring, TX (US)

(72) Inventors: Pierre Belgarric, Bristol (GB); Christopher Ian Dalton, Bristol (GB); David Plaquin, Bristol (GB)

(21) Appl. No.: 17/758,142

(22) PCT Filed: Jan. 30, 2020
(86) PCT No.: PCT/US2020/015817

§ 371 Date: Jun. 29, 2022

(51) Int. Cl. G06F 21/55

(52) U.S. Cl. CPC G06F 21/552; G06F 2221/034

(57) ABSTRACT

In an example, a method includes providing a computing device with an instruction to cause the computing device to execute the instruction. The method further includes monitoring a side channel of a microarchitectural component of the computing device to obtain an indication of whether or not a state of the microarchitectural component changes as a result of the computing device executing the instruction. The method further includes determining whether or not the indication corresponds to an expected state of the microarchitectural component for the instruction.

### BACKGROUND

A computing device may be modified during various stages of the manufacturing process or by an end user. Certain modifications to the computing device may cause the computing device to have different functionality to its functionality prior to modification.

### BRIEF DESCRIPTION OF DRAWINGS

Non-limiting examples will now be described with reference to the accompanying drawings, in which:

FIG. 1 is a flowchart of an example method of determining certain information about a computing device;

FIG. 2 is a simplified schematic illustration of an example computing platform for implementing certain methods;

FIG. 3 is a flowchart of an example method of determining certain information about a computing device;

FIG. 4 is a simplified schematic illustration of an example apparatus for implementing certain methods;

FIG. 5 is a simplified schematic illustration of an example apparatus for implementing certain methods; and

FIG. 6 is a simplified schematic illustration of an example machine-readable medium associated with a processor.

### DETAILED DESCRIPTION

There may be scenarios where a component installed in a computing device is not the same as an expected component or where the component does not function as expected. For example, the component may not be genuine or authorized, or may not function as expected even if it is genuine/authorized. There may be an increased risk of a component not being genuine or authorized in a complex supply chain where there may be an opportunity for an untrusted party to supply or install a non-genuine or non-authorized component.

Certain unauthorized modifications made to the computing device may not be readily detectable to an entity such as a device manufacturer or end user. Such unauthorized modifications may be made for various reasons. For example, a lower cost component of the computing device may be installed during manufacture of the computing device. Another example is that an end user may make an unauthorized change to the computing device. Another example is that the component may implement a backdoor which compromises the security of the computing device.

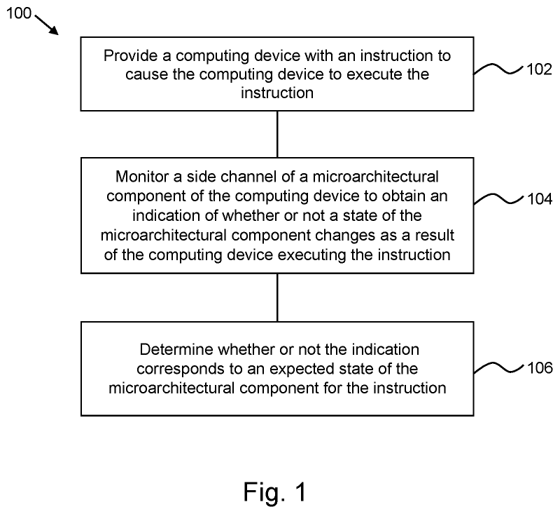

FIG. 1 depicts a flowchart of a method 100, which may be a computer-implemented method, of determining certain information about a computing device. In some examples, the information about the computing device may allow a determination to be made regarding whether or not the computing device has been modified. The method 100 may be implemented by an entity with an interest in determining whether or not the computing device has been modified, such as a device manufacturer or end user (e.g., using a user computer, server or other computing device).

The method 100 comprises, at block 102, providing a computing device with an instruction to cause the computing device to execute the instruction. For example, the instruction may be provided by processing circuitry of, for example, a user computer, server or other computing device. In some examples, the processing circuitry may be caused to generate the instruction, which may then be provided to the computing device (e.g., the processing circuitry may send the instruction to the computing device for execution of the instruction by the computing device). In some examples, providing the computing device with the instruction comprises sending the instruction to the computing device. Upon being received at the computing device, the computing device may proceed to execute the instruction.

The method 100 comprises, at block 104, monitoring a side channel of a microarchitectural component of the computing device to obtain an indication of whether or not a state of the microarchitectural component changes as a result of the computing device executing the instruction.

Certain instructions may comprise a payload which causes a microarchitectural state change that depends on the design of the microarchitecture of the computing device. In some examples, the instruction comprises a code kernel (e.g., an example of a payload) to cause an expected change in state of the microarchitectural component that depends on a design of the microarchitectural component.

Certain information about the microarchitecture may be determined by monitoring the side channel while the computing device is executing the instruction. For example, activity of the computing device during execution of the instruction may lead to characteristic changes in the side channel response (e.g., side channel leakage) as a result of executing the instruction. In some examples, monitoring the side channel may comprise monitoring power consumption of the computing device and/or measuring electromagnetic radiation generated by the computing device.

By monitoring the side channel, a determination may be made as to whether or not the side channel response corresponds to the expected change in the microarchitecture. For example, the payload may be designed to cause a certain operation to be carried out by the computing device. In some examples, such an operation may be anticipated to vary a power consumption and/or electromagnetic emission by the computing device in a certain way due to the design of the payload. In some examples, such changes may be associated with increased or decreased power consumption and/or electromagnetic emission (i.e., compared with an instruction not designed to cause such a change to occur).

In some examples, the instruction may be specially designed to cause the change in state. In other words, the instruction may be intended to cause some leakage from the side channel. This leakage can be analyzed to determine information regarding the provenance of the computing device.

The method 100 comprises, at block 106, determining (e.g., using processing circuitry) whether or not the indication corresponds to an expected state of the microarchitectural component for the instruction.

The instruction may be designed to cause the microarchitectural component to be in or transition to the expected state. If the indication corresponds to the expected state, this may indicate that the microarchitectural component is functioning as expected (e.g., if the computing device is operating as expected). However, if the indication does not correspond to the expected state, this may indicate that the microarchitectural component is not functioning as expected (e.g., if the computing device is not operating as expected). Depending on whether or not the indication corresponds to an expected state, further action may be taken. In some examples, the indication may be indicative that the computing device is not functioning as expected and therefore a user or a verifying entity may be informed accordingly (e.g., so that appropriate action may be taken).

In some examples, the expected state may refer to the state of the microarchitectural component at a certain time. In some examples, the state of the microarchitectural component may evolve over time. At any point during this time, the state of the microarchitectural component may change (e.g., due to the evolution) and this may be apparent from the indication (e.g., from a single indication at a certain time or from multiple indications over time). Thus, in some examples, the expected state may refer to an expected evolution of the state of the microarchitectural component.

In some cases, a provenance of the computing device may be called into question by virtue of determining whether or not the indication corresponds to the expected state of the microarchitectural component for the instruction. For example, the expected performance of the computing device may be affected by whether or not a component of the computing device is genuine/authorized. A certain side channel (e.g., corresponding to power consumption, electromagnetic radiation leakage, or any other parameters of interest) of the computing device may be monitored while the computing device is active (e.g., during execution of the instruction) to determine whether or not the side channel response is as expected or not. In some examples, where the side channel response differs from the expected side channel response, this may indicate that a component of the computing device may not be genuine/authorized, or at least that the component is not functioning as expected.

Some microarchitectural design choices may result in certain differences (for a given microarchitectural component of the computing device) in terms of the state of the microarchitecture depending on the executed payload. For example, the number of activated pipelines in a superscalar design may vary due to the contention of execution units of the microarchitecture. For example, if there are two pipelines (e.g., one arithmetic multiplication unit and two arithmetic units capable of performing additions), an instruction comprising a multiplication payload may activate one pipeline while an instruction comprising a payload of additions may activate the two pipelines. In some examples, the difference in the activation (or deactivation) of one pipeline may represent many gates being used (or not being used). The macroscopic nature of this change may be visible in the side channel. Where a computing device implements a different microarchitecture to what is expected (e.g., if the computing device is not genuine, not functioning as expected or has been otherwise compromised), the side channel response may not be capable of mimicking the side channel response of a computing device with the expected microarchitecture.

In some examples, methods, apparatus and machine-readable media described herein may facilitate detection of whether or not a hardware component in a computing device corresponds to the expected hardware component. The expected hardware component may refer to a specified hardware component provided at design time for a given product. Thus, where a hardware component in a computed device is detected to be different to what is expected, this may indicate that the manufactured product (e.g., computing device) differs from the expected product at design time.

By way of example, a component verification for a given computing device may involve running a certain code kernel or a plurality of code kernels. A side channel associated with the activity of the computing device may be monitored while running the certain code kernel(s). This activity may be recorded and/or post-processed to extract features of the side channel that may be used to characterize the computing device.

Depending on the characterization outcome, a certain mechanism may be triggered in order to take appropriate action for the given outcome. For example, the mechanism may involve at least one of: reporting the outcome/result of the characterization (e.g., a value corresponding to or indicative of a side channel response); and restricting functionality of the computing device (e.g., to prevent or reduce the risk of the computing device or other parts of a platform being adversely affected by a potentially compromised computing device).

In some examples, post-processing and/or characterization of a signal derived from monitoring the side channel may be performed locally on a platform associated with the computing device. For example, the platform may comprise an environment that is isolated from the component being checked. In some examples, the post-processing and/or characterization of the signal derived from monitoring the side channel may be performed remotely (e.g., by a server or cloud-based service) by sending the data from the side channel (e.g., protected by a cryptographic technique) over a network communicatively coupling the computing device/platform to the remote server or cloud-based service.

In some examples, the methods, apparatus and machine-readable media described herein may be used to identify a change of component (e.g., in the supply chain or by an end user) to one of a different product family (e.g., a different component brand or an unauthorized component). Methods, apparatus and machine-readable media described herein may yield information corresponding to a fingerprint of the computing device during manufacturing (i.e., where trusted). Once deployed to a user or later in the manufacturing process (either of which may be untrusted for any reason), the fingerprint may be checked (e.g., repeatedly and/or at specified times) to detect if a computing device has been modified. The fingerprint may be linked to well-understood or anticipated behavior or functionality of the computing device.

In some cases, a modification may be expected to occur and the fingerprint may be used to ascertain whether or not the modification has been performed as expected. In some cases, the modification may not be expected to occur and the fingerprint may be used to identify that this modification has occurred.

In some examples, a pre-qualification may be performed to define a reference component which can be trusted (e.g., in a trusted environment such as when the computing device is in a trusted manufacturing facility). In other similar words, a fingerprint for the computing device may be obtained in accordance with certain methods described herein and this fingerprint may be used to ascertain whether or not certain modifications have been made to the computing device once the computing device has left the trusted environment. In some examples, the reference component may be referred to as a ‘golden component’. In some examples, the fingerprint for the computing device obtained using the pre-qualification may be referred to as a ‘golden fingerprint’.

The pre-qualification may be used to record the side-channel response associated with a specified instruction (e.g., code kernel). In this procedure, a characteristic of the side-channel response may be acquired and, in some examples, may be post-processed and/or analyzed. Any number of characteristics may be acquired in order to fingerprint the computing device.

Different computing devices may have different side channel responses depending on the platform supporting the computing device. In which case, to reflect the expected side-channel for the computing device whose component(s) are to be fingerprinted, a golden fingerprint may be constructed from measurement(s) performed on the same platform (e.g., to account for the impact of the overall platform on the computing device, e.g., due to energy savings modes) and/or in different environments (e.g., to account for future measurements which may be performed in uncontrolled environments).

In some examples, a side-channel simulation may be performed to obtain an estimated side channel response. Such a simulation may be performed in conjunction with other procedures described herein such as the pre-qualification. In some examples, the simulation may be based on certain knowledge of the computing device such as a netlist. In some examples, the simulation may be based on certain measurements such as obtained by monitoring the side channel of the computing device.

As referred to previously, a computing device's side-channel response associated with a specified instruction may be based on a pre-qualification using a golden component. However, in some examples, certain side-channel responses may follow a predictable pattern based on knowledge of the microarchitecture. For example, such knowledge may predict that an electromagnetic emission and/or power consumption may decrease with a transition from a given payload to another payload. A certain pattern may be observed from the side channel response when different payloads are provided to the computing device. Even if such a pattern is coarse-grained, this information may be used in various ways, as explained below.

In some examples, if no pre-qualification was possible, such coarse-grained behavior may be identifiable in a side channel leakage profile, for example, in a verification procedure.

In some examples, an expected side channel leakage profile may be estimated based on a computer simulation of the microarchitecture state when running the code kernel. Such an estimated side channel leakage profile may be coarse-grained.

In some examples, the pattern may be used to help build the side channel leakage profile during pre-qualification. Although the pattern may be coarse-grained, this pattern information may be used by itself or with other information in order to build the side channel leakage profile.

In some examples, a side channel simulation may help to identify a (e.g., new) side channel leakage profile that an evolution of the microarchitecture state may generate. For example, the instruction may cause the microarchitecture state to evolve in a specified or predictable way. Accordingly, different microarchitecture states may be detected at different times depending on how the state evolves.

In some examples, a microarchitecture state space may be searchable in an automated way (e.g., to identity at least one of several possible microarchitecture states).

In some examples, the side channel response of a computing device may be monitored and a determination may be made as to whether or not the side channel response over a specified period of time corresponds to an expected evolution of the microarchitecture state of the computing device over the specified period of time.

In some examples, a signal-to-noise ratio (SNR) of the side channel response may be increased because the side channel response (e.g., side channel leakage profile) may depend on the activation/deactivation (or not) of many hardware blocks. For example, the SNR may be increased compared with the side channel response where a single or a few hardware blocks are activated/deactivated. In other similar words, the greater the number of hardware blocks (e.g., of the microarchitecture) of the computing device that may be activated or deactivated at a particular time (e.g., during executing the instruction or transitioning between executing different payloads), the side channel response may be sufficiently large to be detectable over the noise. As mentioned above, the instruction may be designed to generate a specified side channel response or cause side channel leakage. In the above example, the instruction may be designed to cause a large number of hardware blocks to be activated/deactivated in response to executing the instruction (e.g., to increase the SNR compared with activating/deactivating a smaller number of hardware blocks).

Certain computing devices (such as some solid state drives) may be removable or replaceable (e.g., due to be being pluggable), which may represent a security risk in the case of a replacement/returned computing device being compromised. In the event that a replacement/returned computing device is compromised, certain methods, apparatus and machine-readable media described herein in may notify a user or a verifying entity of the potential security risk.

Certain methods, apparatus and machine-readable media described herein may, in some examples, have utility in non-security use cases such as Device as a Service (DaaS), for example, to list the computing devices to be upgraded in the field. For example, in a DaaS context, a customer may subscribe to a periodic payment service in which the original equipment manufacturer (OEM) or another service provider provides the computing device and manages the device (e.g., via management software and/or offering a replacement device at certain times). Where a previously-deployed device is provided to a new user (e.g., if the OEM or another entity refurbishes the device), the OEM may be able to use methods described herein to establish whether or not the device has been modified by the previous user, the other entity and/or during transit. Thus, the OEM may be able to track the device and protect the end user from an attack which may have occurred in an untrusted environment.

In some examples, end users may associate a certain trust level with a computing device in their own working environment, which may be less than the trust level associated with a different environment such as in a manufacturing facility. Upon receiving the computing device from the different environment, an end user may be able to run a check of the computing device to determine whether or not the computing device can be trusted.

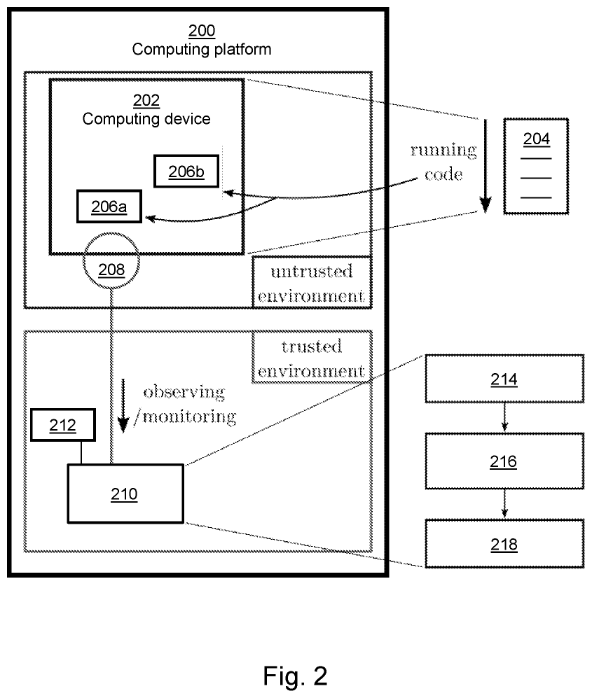

FIG. 2 depicts a computing platform 200 for implementing methods described herein such as the method 100 described above or the method 300 described below. The system 200 may facilitate determining certain information about a computing device 202 forming part of the platform 200. In this example, the computing device 202 represents an untrusted environment of the computing platform 200. In other words, the provenance of the computing device 202 may not yet have been established or it may be considered to be untrusted.

As depicted by FIG. 2, an instruction may comprise a payload 204 which is caused to be executed by the computing device 202 (e.g., the payload 204 comprises code to be run by the computing device 202). In this example, the computing device 202 comprises two microarchitecture parts 206a, 206b of interest (although in some examples a different number of microarchitecture parts such as one or at least two microarchitecture parts may be of interest). Executing the instruction may cause at least one of the microarchitecture parts 206a, 206b of interest to exhibit a certain characteristic that can be detected in a side channel. For example, the instruction may affect the state of at least one of the microarchitecture parts 206a, 206b of interest, and this may be detectable via the side channel.

In this example, a sensor 208 is located in an appropriate location and/or designed for monitoring a certain side channel of the computing device 202. The sensor 208 may comprise an appropriate interface (e.g., comprising at least one of: a hardware probe and a software probe, as described in more detail below) for detecting the side channel response. Although a single sensor 208 is depicted, a plurality of sensors 208 may be deployed for monitoring multiple side channels. In some examples, the sensor 208 may comprise an analog (i.e., rather than a digital) interface to reduce the risk of an attack between the untrusted environment and a trusted environment of the computing platform 200 (as depicted by FIG. 2). An analog interface may prevent or reduce the risk of a digital signal from the computing device 202 compromising the trusted environment of the computing platform 200. In some examples, using an analog interface may help to ensure that the trusted environment is well isolated from the untrusted environment.

The trusted environment of the computing platform 200 comprises processing circuitry 210 (e.g., of a user computer, server or cloud-based service) for implementing certain methods described herein. The processing circuitry 210 is communicatively coupled to the sensor 208 in order to receive data from the sensor 208 (e.g., to enable the processing circuitry 210 to monitor the side channel of the computing device 202). Although not shown, the processing circuitry 210 may cause the computing device 202 to provide the computing device 202 with the instruction (e.g., payload 204) by either directly sending the instruction to the computing device 202 or causing other processing circuitry (not shown) to send the instruction to the computing device 202. In some examples, the processing circuitry 210 may be able to access a memory 212 such as a database comprising information which can be used for implementing certain methods described herein. For example, the memory 212 may store a potential payload 204 to be used as the instruction to be executed by the computing device 202. In some examples, the memory 212 may store certain information to facilitate determination of whether or not the indication corresponds to an expected state of the microarchitectural component for the instruction (e.g., block 106 of the method 100).

In this example, the processing circuitry 210 comprises a pre-processing module 214 for performing pre-processing on the signal obtained by the sensor 208. The pre-processing may provide data related to the signal in an appropriate form to be analyzed by further processing.

The processing circuitry 210 further comprises a characterization module 216 for implementing certain methods described herein. For example, the characterization module 216 may implement block 106 of the method 100.

The processing circuitry 210 further comprises a decision-making module 218 for implementing certain methods described herein. For example, the decision-making module 218 may take appropriate action in response to the output of the characterization module 216. For example, if the characterization module 216 identifies a potential concern that the computing device 202 is not genuine, not authorized or otherwise not functioning as expected, the decision-making module 218 may at least one of: issue a notification to a user or verifying entity to inform of the potential concern; and cause a restriction of the functionality of the computing device 202 (e.g., until such time that the potential concern has been suitably addressed).

In some examples, any of the modules described above (e.g., the pre-processing module 214, the characterization module 216 and/or the decision-making module 218) may comprise at least one dedicated processor (e.g., an application specific integrated circuit (ASIC) and/or field programmable gate array (FPGA), etc) for implementing the functionality of the module.

In some examples, the module (e.g., the pre-processing module 214, the characterization module 216 and/or the decision-making module 218) may comprise at least one processor for implementing instructions which cause the at least one processor to implement the functionality of the module described above. In such examples, the instructions may be stored in a machine-readable medium (not shown) accessible to the at least one processor. In some examples, the module itself comprises the machine-readable medium. In some examples, the machine-readable medium may be separate to the module itself (e.g., the at least one processor of the module may be provided in communication with the machine readable medium to access the instructions stored therein).

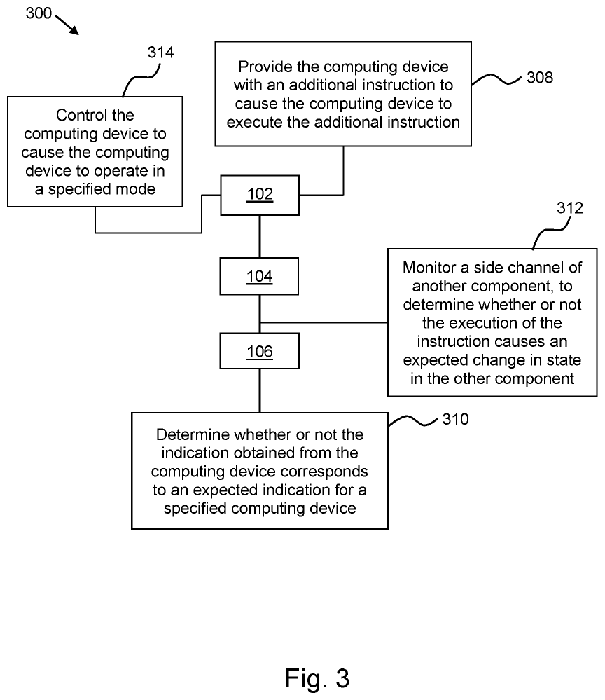

FIG. 3 depicts a flowchart of a method 300, which may be a computer-implemented method, of determining certain information about a computing device. The method 300 may be implemented as part of or in conjunction with the method 100 of FIG. 1. In the depicted example, the method 300 comprises the blocks 102 to 106 of the method 100. Similar to method 100, the method 300 may be implemented by an entity with an interest in determining whether or not the computing device has been modified, such as a device manufacturer or end user (e.g., using processing circuitry such as a server communicatively coupled to the computing device). Any of the blocks of the method 300 may be omitted, moved relative to other blocks or otherwise modified, where appropriate.

In some examples, the method 300 comprises, at block 308, providing the computing device with an additional instruction to cause the computing device to execute the additional instruction. The computing device may be provided with the additional instruction by sending the additional instruction from, for example, a verifying entity to the computing device. The instruction and the additional instruction may each comprise a different code kernel. The code kernel of the additional instruction may be expected to have a different effect on the state of the microarchitectural component for the design of the microarchitectural component compared with the code kernel of the instruction. Execution of the instruction and the additional instruction by the computing device may provide the indication. In some examples, the method 300 may construct or select the code kernel of the additional instruction based on the result of executing the (e.g., previous) instruction. For example, the instruction may result in a certain change (or no change) in the state of the microarchitectural component occurring, and this information may be used to construct or select the additional instruction (e.g., by constructing or selecting a code kernel which is more likely to result in a certain change if the initial/previous instruction did not cause any change in state).

In some examples, the computing device may be caused to switch between executing the instruction and the additional instruction. For example, the computing device may be caused to execute the instruction and then execute the additional instruction, or vice versa. In some examples, the instruction and the additional instruction may be executed for a single run each. In some examples, at least one of the instruction and the additional instruction may be run repeatedly and/or at specified times.

In some examples, the computing device may switch between executing instructions that lead to contention of execution units and instructions that do not lead to such contention, which may lead to a change in the number of instructions that may be executed in parallel in a superscalar design. For example, more contention may lead to fewer pipelines being activated. Certain code kernels may not provide information of interest with some microarchitectures (e.g., some examples may not lead to a measurable change in a single pipeline architecture). In some examples, a set of different code kernels may be used to increase the chance that at least one of the code kernels may lead to a modification of the microarchitectural state. The set of code kernels may vary depending on the type of computing device implementing the instruction. For example, the instruction may be tailored to the specified type of computing device (e.g., a central processing unit (CPU), a network interface controller (NIC), a controller of a peripheral (e.g., a controller for an SSD, chipset, or other peripheral device)).

In some examples, monitoring the side channel comprises acquiring a characteristic of the side channel that depends on activity of the computing device. The characteristic may be acquired from a probe for monitoring the side channel.

In some examples, the probe comprises a hardware probe. The hardware probe may comprise a sensor for detecting at least one of: a power consumption level, an electromagnetic emission or other characteristic of the computing device.

In some examples, the probe comprises a software probe (e.g., software-based mechanism for detecting the side channel response). The software probe may monitor the effect of the execution of the instruction by detecting characteristic changes (or the effect) of the microarchitectural state of the computing device. In some examples, a timing or other parameter affected by the instruction execution may be monitored by the software probe. For example, if the timing of the instruction execution is different to the expected timing, this may indicate that the computing device is not functioning as expected, which may be suggestive of an anomaly to be investigated by an end user or a verifying entity. In some examples, the software probe may be used where a hardware probe cannot be deployed or where it is not appropriate to deploy a hardware probe. A software probe may be relatively straightforward to implement since no dedicated hardware may need to be used to perform the side channel monitoring.

As mentioned previously in relation to FIG. 2, the computing device may define or be in an untrusted environment. In which case, security of the observation environment (e.g., of the entity performing the side channel characterization) may be relevant for ensuring that any compromise in the computing device does not adversely affect the overall computing platform. In this regard, the side channel monitoring and analysis may be performed in an environment that is trusted (i.e., in an environment that is isolated from an untrusted environment).

Certain elements may be used to provide protection from a compromised component under isolation, or from an attacker. In some examples, the integrity of the measured signal (i.e., the signal generated by monitoring the side channel) may be protected. For example, a signal integrity monitoring system (e.g., a ‘watchdog mechanism’) may observe the signal to determine whether or not any security concerns are raised during the monitoring. Such concerns may arise if measurements of the signal are interrupted for some reason or if the measurements are in some way out of bounds. In some examples, any post-processing and/or characterization of the signal may be protected (e.g., to ensure that the outcome of the post-processing and/or characterization is not compromised in some way).

In some examples, the hardware probe may provide protection from a compromised component under isolation. In the case of a physical side channel (e.g., electromagnetic emission, power consumption of the computing device), the probe may be analog. In some examples, the analog probe may be discrete from the computing device under evaluation (i.e., not implemented as part of the circuitry of the computing device), which may avoid or reduce any concerns that an embedded hardware probe may be compromised and thus return erroneous and/or falsified measurements. This physical separation and the analog channel between the hardware probe and the trust environment of the computing platform may make it difficult for a malicious computing device under observation to compromise the observation system (i.e., another part of the computing platform) via this channel.

In some examples where a microarchitectural side channel is being observed, the monitoring may be performed in a secure enclave of the computing device. In some examples, the code (e.g., instruction) run may affect the state of the microarchitecture while also measuring the state of the microarchitecture. In some examples, running a first code (e.g., a first instruction) may affect the state of the microarchitecture. Running a second code (e.g., a second instruction) may measure the state of the microarchitecture.

A potential concern in the case of microarchitectural measurements (e.g., using a software probe that runs on the computing device being fingerprinted) may be that a rogue component of the computing device may fool the measurement software. In some examples, a software probe may offer a lower-cost solution to monitoring the side channel (in comparison to physical measurement with a hardware probe). In some examples, the software probe may be capable of detecting a change of a component of the computing device with another component (e.g., of lower value) that was not designed to fool the fingerprinting solution.

In some examples, the characteristic (i.e., of the side channel that depends on activity of the computing device) comprises at least one of: a power consumption of the computing device; an electromagnetic signal (e.g., electromagnetic emission); an optical signal (e.g., an example of an electromagnetic emission and/or dedicated optical channel used to convey information via the optical signal); a spatial profile of the electromagnetic signal; heat generated by the computing device; an execution time for the instruction; a cache status of the computing device; an arithmetic logic unit (ALU) congestion status (e.g., the ALU may provide an indication of its congestion status, e.g., via an ALU side channel); a software-derived fingerprint indicative of the activity; a hardware-derived fingerprint indicative of the activity.

A software-derived fingerprint may refer to an effect of the execution of the instruction on some operating parameter of the computing device that is observable to software. For example, an execution time of the instruction may be detectable by software, which may be used to determine whether or not the computing device is genuine/authorized, or functioning as expected.

In some examples, an execution time for the instruction may be indicative of whether or not the indication corresponds to the expected state of the microarchitectural component for the instruction. For example, if the time taken for executing the instruction takes longer (or shorter) than expected, this may indicate a potential concern that the computing device is not functioning as expected, so that appropriate action may be taken.

In some examples, the cache status of the computing device may be indicative of whether or not the indication corresponds to the expected state of the microarchitectural component for the instruction. For example, a cache usage may be detectable as a side channel. Thus, as the instruction is being executed, the cache status may change or evolve in a manner that depends on how the computing device is configured. If the computing device is not genuine/authorized or not functioning as expected, the cache status may not change or evolve as expected, which may be reflected by the side channel response.

The term ‘side channel’ is used throughout this description. For the avoidance of doubt, the term ‘covert channel’ may be regarded as an example of a side channel.

In some examples, the characteristic may be based on a fine-grained spatial characterization. Certain side-channels may exhibit a spatial profile, which may be dependent on the implementation of components of the computing device. As mentioned above, the characteristic may comprise a spatial profile of the electromagnetic signal. For example, electromagnetic radiation may have a different property (e.g., intensity, signal strength and/or direction) at different locations of the computing device. The probe may be sensitive to the spatial profile, which may be used for characterizing the computing device.

In some examples, a sensor for monitoring the side channel may be tuned or otherwise designed to either measure the overall activity of the computing device (e.g., if the differences in the microarchitecture state are sufficiently large, it may be possible to detect such differences) or measure an emanation (e.g., side channel leakage) from a subpart of the computing device and/or of its power circuitry. In this example, the SNR may be increased by measuring the emanations from the subpart (which may involve observing the activity of a part of the microarchitecture). In some examples, a set of local measurements that collectively cover some spatial area of the computing device may provide certain fine-grained information about the microarchitecture. A set of local measurements may increase the SNR and/or may provide an indication of an evolution of some sub-parts of the microarchitecture. Spatial measurement may be performed with a set of sensors (e.g., for concurrently measuring the side channels in several locations) and/or or using a movable sensor that measures sequentially in several points while repeating the execution of the instruction (e.g., code kernels). In some examples, the sensor may comprise a plurality of sensors for detecting the side channel. In some examples, the sensor may be capable of performing beamforming, for example, to detect the side channel at a location to be specified by a beamforming operation. Thus, the sensor may be capable of targeting a specified location when monitoring the side channel (e.g., to allow the sensor to monitor the side channel at different locations without the sensor itself being moved).

In some examples, the method 300 comprises obtaining the indication by monitoring a plurality of side channels and aggregating the characteristic acquired from the plurality of side channels.

For example, the activity of the computing device while executing the instruction may lead to the generation of a plurality of side channels. These side-channels may carry different types of information. Aggregating information from several sources of leakage (e.g., several different side channel responses) may at least one of: increase the amount of information gathered (e.g., which can be used for verification purposes, or improving an estimate of the side channel response); provide a degree of redundancy on a measured value. Information may be aggregated at several stages of the side channel monitoring (e.g., observation) pipeline to facilitate verification and/or improvement of the estimation of the side channel response. Such aggregation may be performed before or after the characterization of the indication (e.g., in accordance with block 106 of the method 100).

As mentioned above, post-processing may be used to facilitate certain methods described herein. In some examples, a post-processing technique such as signal processing and/or a machine learning-based approach may be used to increase the signal-to-noise ratio or to extract features of interest from the indication. The processing circuitry for implementing the post-processing technique may be the same or different to the processing circuitry for implementing certain blocks of the method 100. The processing circuitry for implementing the post-processing technique may comprise at least one of: a general-purpose processor or a domain-specific architecture, e.g., a digital signal processor (DSP), a machine learning (ML) accelerator, among other hardware implementations. In some examples, the processing circuitry for implementing the post-processing technique may be provided by a computing entity such as a user computer, server or cloud-based service. The post-processing environment may be appropriately isolated from the computing device intended to be fingerprinted according to certain methods described herein.

In some examples, the method 300 comprises, at block 310, determining whether or not the indication obtained from the computing device corresponds to an expected indication for a specified computing device. The specified computing device may be one of: an authorized computing device; or a non-authorized computing device. Thus, the indication may be used to determine if the computing device being tested is authorized, or not. In some examples, the computing device may be tested in accordance with certain methods described herein and then the indication may enable an end user or verifying entity to determine whether or not the computing device can be trusted.

In some examples, classification (e.g., using a classification engine) of the indication may be used to characterize whether or not the computing device implements the microarchitecture of the intended component (or may map to the microarchitecture of a blacklisted component). The classification procedure may be combined with or distinct from the post-processing procedure described above.

In some examples, the method 300 comprises, at block 312, monitoring a side channel of another component to determine whether or not the execution of the instruction causes an expected change in state in the other component. In this regard, the computing device and the other component may be communicatively coupled to each other. The computing device may comprise multiple components, any of which may have an associated side channel. It may be possible to monitor the side channel associated with a particular component and infer that an unauthorized modification has occurred to another component of the computing device based on the effect that the unauthorized modification has on the overall functionality of the computing device.

In some examples, monitoring the side channel of the component and the other component (e.g., using different probes) may be referred to as multicomponent fingerprinting (i.e., a fingerprint for each component under test may be acquired). The fingerprinting of multiple components of the computing device may be performed concurrently (i.e., at the same time) and/or independently (e.g., using different probes and/or at different times) for each component of interest.

In some examples, multicomponent fingerprinting may involve a common activity between several components, e.g., memory accesses from a processor of the computing device into a memory. In some examples, any side-channels measured on the several components involved may provide more information than the side channels being measured independently. For example, with the memory accesses described above, the combination of side channels from both the processor and the memory may reveal more information about the cache hierarchy than the side-channel associated with the processor alone (e.g., because cache misses may be more visible on the memory side).

In some examples, if the processor of the computing device is replaced, certain changes to the cache functionality may occur, for example, the cache might be slower to clear than expected, more likely to involve cache misses and/or store less data (in other words, the processor may work in a slightly different way to that expected). Such a change may lead to the computing device working in a slightly different way (e.g., the computing device may be slower than expected, operate with a different error rate and/or cause certain changes to the cache functionality), and this may be detectable from a side channel response. In some examples, a component of a computing device may be changed, which may affect the operation of other components of the computing device. For example, a change in random access memory (RAM) to less ‘RAM’ may lead to slower overall operation of the computing device. Thus, any change to a component of the computing device may affect another component, or indeed the overall operation of the computing device.

In some examples, the method 300 comprises controlling, at block 314, the computing device to cause the computing device to operate in a specified mode. The method 300 further comprises, at block 314 (e.g., as part of or in conjunction with block 104), monitoring the side channel to determine whether or not the indication is as expected for the computing device operating in the specified mode. In some examples, operating the computing device in the specified mode comprises causing the computing device to operate out of specification. In some examples, operating the computing device in the specified mode comprises identifying a valid operating value, within specification, and causing the computing device to operate according to the valid operating value. Thus, block 314 may involve causing or setting the computing device to operate in a particular way that may be considered to affect how the instruction is executed. By monitoring the side channel, a determination may be made as to whether or not the indication corresponds to the expected state of the computing device for the given instruction and the specified mode.

In some examples, certain faults may be observed within a side channel where the computing device is operating in a specified mode. Thus, certain faulty behavior may be generated while executing a certain instruction. An example way to do so may be for the computing device to operate under operating values out of the specification, e.g., low voltage or high-frequency power input. These ‘faults’ may lead to a behavior that is visible within the side channel. In some examples, the computing device may implement a fault detection and/or recovery mode to be implemented in the computing device, which may affect how the instruction is executed. In some examples, the ‘fault’ may lead to an evolution of the microarchitecture that was not the one expected, and this evolution may be representative of the netlist of the computing device and/or the associated microarchitecture.

In some examples, certain variations in the side channel response may be observed depending on operating values. A component of the computing device may be made to operate in accordance with a valid operating value (e.g., there may be a valid range for the operating value within which the computing device may operate) or under a set of valid operating values. By way of example, certain operating values may be leveraged to dynamically tune between energy and performance within computing platforms (for example, dynamic voltage and frequency scaling (DVFS) where the frequency and the voltage are adjusted according to a specified metric). The side channel observed may vary depending on these operating values (even if the microarchitectural state may evolve in the same way while the computing device is operating ‘within specification’). For example, if the frequency is slowed down, the time scales involved for executing the instruction may be extended, while the rate of consumption of energy may be decreased.

The overall profile pattern of the side channel response may be the same. In some examples, the state of the microarchitecture may evolve in the same way as mentioned above. In some examples, if several components evolve under several clock rates (e.g., where there are several cores) and share some microarchitectural component, e.g., the last-level cache (LLC), the state of the microarchitecture may not necessarily evolve in the same way, and this difference in evolution may be detectable. A property of the signal corresponding to the side channel may vary in certain ways depending on the overall profile pattern. Evaluating the side channel leakage when the computing device is operating under several operating conditions may yield additional information to be considered due to these variations. In some examples, the post-processing and/or characterization procedures described above may be designed in a way that makes signal analysis agnostic from these variations.

In some examples, a data race in the microarchitecture of a shared cache may occur under certain circumstances, and the evolution of the state of the microarchitecture may be detectable depending on the nature of the data race. For example, if the computing device is not functioning as expected, the evolution of the state may vary compared to what is expected.

In some examples, a data race may produce some non-erroneous behaviors in the microarchitecture but these behaviors may not be explicitly managed. Thus, the state of the microarchitecture may vary depending on a certain operating condition while the behavior still complies with specification and/or is within the bounds of expected behavior. Even if a data race occurs, this may indicate that the microarchitecture is operating as expected. However, the way in which a data race occurs in a compromised device may be different to what is expected. Thus, by monitoring the data race, a determination may be made as to whether or not the device is compromised.

In some examples, determining whether or not the indication corresponds to the expected state of the microarchitectural component for the instruction comprises identifying whether or not an evolution of the indication over a period of time is at least one of: probabilistic and deterministic.

If a computing device design is closed-source (or because the evaluation of the microarchitecture is too complex/lengthy), the precise implementation of the microarchitecture may not be identifiable. In some examples, certain observations of the evolution of the microarchitecture may appear to be probabilistic rather than deterministic. In some examples, execution of the instruction may lead to an evolution of the microarchitecture that does not appear to be deterministic. For example, a code kernel may be executed several times as the same code, but as the microarchitecture was in a different state each time this same code started running, the state of the microarchitecture may evolve differently each time the code kernel is executed. Concurrency (e.g., where there are variations in terms of the operating values for the computing device) may lead to non-reproducible behavior. Nonetheless, the evolution of the state may exhibit some statistical properties that may be leveraged to fingerprint the microarchitecture. In some examples, the microarchitecture may be forced to be in a given state by running some code or by using any mechanism provided by the hardware before running a code kernel corresponding to the instruction.

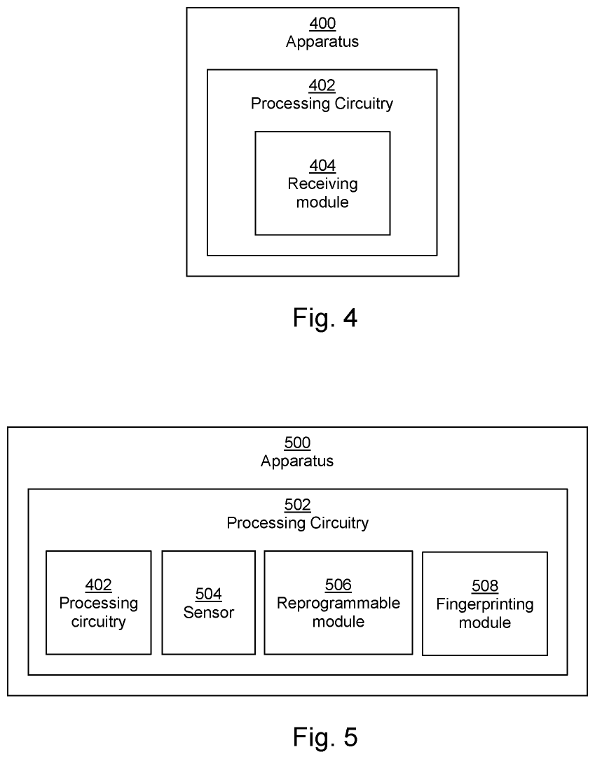

FIG. 4 is a schematic illustration of an example apparatus 400 for implementing certain methods described herein. The apparatus 400 comprises processing circuitry 402 (e.g., for implementing certain methods described herein). In this example, the processing circuitry 402 comprises a receiving module 404. In use, the receiving module 404 receives an instruction to cause a microarchitectural component of the processing circuitry 402 to operate in a specified manner. Thus, the receiving module 404 may receive the instruction referred to in block 102 of the method 100. The apparatus 400 may implement the instruction and a side channel of the apparatus 400 may provide an indication of whether or not the microarchitectural component operates in the specified manner as a result of the processing circuitry 402 implementing the instruction.

The apparatus 400 may be an example of the ‘computing device’ described above. The apparatus 400 may comprise or provide a side channel, which may provide the side channel response that is detected by a probe such as described above. The information acquired by the probe may provide the indication referred to above, and this indication may be analyzed by processing circuitry of the computing platform (e.g., see FIG. 2) to determine whether or not the apparatus 400 is genuine/authorized or functioning as expected. Any component of the apparatus 400 may be associated with a particular side channel such that the indication provided by that side channel may be indicative of the functioning of another component (which may itself be associated with another side channel).

FIG. 5 is a schematic illustration of an example apparatus 500 for implementing certain methods described herein. The apparatus 500 comprises processing circuitry 502 (e.g., for implementing certain methods described herein). The processing circuitry 502 comprises the processing circuitry 402 of FIG. 4.

In some examples, the apparatus 500 further comprises a sensor 504 (e.g., such as described above) to monitor a side channel of the apparatus 500. In use, the sensor 504 obtains the indication (e.g., by detecting a characteristic of the side channel) and causes the indication to be sent to a trusted environment (e.g., as described in relation to FIG. 2). In this example, the sensor is implemented as part of the processing circuitry 502 (for example, the sensor 504 may comprise and/or be implemented by a software probe). In some examples, the sensor may not form part of the processing circuitry 502 but may still form part of the apparatus 500 (for example, the sensor 504 may comprise a hardware probe).

In some examples, the apparatus 500 further comprises a reprogrammable module 506. The reprogrammable module 506 comprises the microarchitectural component of the processing circuitry 502.

In some examples, logic in the reprogrammable module 506 (e.g., a field programmable gate array (FPGA) or other reprogrammable device) may implement a high-level organizational structure akin to the microarchitecture of the apparatus 500. Thus, in some examples, the reprogrammable module 506 may form part of the processing circuitry 402. The organization of the reprogrammable module 506 may be probed to check that the logic implemented is the one expected (e.g., a bitstream may be indicative of the logic being implemented) and/or that the FPGA/reprogrammable device is the one expected. In some examples, the bitstream of the reprogrammable module 506 itself may be indicative of whether or not the implementation of the reprogrammable module 506 is the one expected. In some examples, the output from the reprogrammable module 506 resulting from an input (e.g., a signal or input data) to the reprogrammable module 506 may be indicative of whether or not the implementation of the reprogrammable module 506 is the one expected.

In some examples, a fingerprinting procedure may involve checking that the bitstream is the one expected (or at least closely related to the expected bitstream) by varying the input (e.g., input signal) to be processed. Another (different) bitstream may leak differently for the same processed inputs. Thus, the bitstream itself, rather than a hardware component, may be characterized.

In some examples, the implementation of the bitstream on a given FPGA/reprogrammable device may lead to a specific routing (e.g., data routing direction and/or location-specific hardware activation or deactivation) in comparison to an expected implementation of the bitstream that a processed input (e.g., a code kernel) may highlight. For example, by observing the routing, it may be possible to determine the implementation of the bitstream on the FPGA/reprogrammable device (and hence determine whether or not the implementation is the one that is expected). In some examples, the observed routing may be indicative of a change in the bitstream.

In some examples, the logic of the reprogrammable module 506 may be periodically changed (e.g., changed at a specified time). If an apparatus 500 does not implement the expected logic at a given time (e.g., because the apparatus 500 is disconnected from an update system, or because an updated logic is designed to run on the expected apparatus 500 and not an unexpected apparatus 500), a determination may be made that the apparatus 500 is not functioning as expected and further action may be taken accordingly. By examining the logic implemented at a given time, it may be possible to authenticate that the apparatus 500 functions as expected.

In some examples and as mentioned previously, the bitstream on different FPGAs/reprogrammable devices may be routed differently (e.g., because of the hardware architecture or the development kit used). If it is possible to dynamically reprogram the FPGA/reprogrammable device, the characterization of the hardware may be performed with a set of bitstreams that process a set of inputs. A dynamic property of the bitstream and/or the processed inputs may be leveraged to characterize the underlying hardware (e.g., the FPGA/reprogrammable device). For example, a bitstream may depend on how the logic is implemented. By dynamically reprogramming the reprogrammable module 506, the bitstream may be analyzed to determine whether or not the bistream corresponds to an expected bitstream given the logic being implemented and/or the input to the reprogrammable module 506.

In some examples, the apparatus 500 further comprises a fingerprinting module 508. In use, the fingerprinting module 508 causes the microarchitectural component to operate in the specified manner. The fingerprinting module 508 may be activated in response to receiving the instruction.

For example, the instruction may be designed to activate the fingerprinting module 508. Providing the apparatus 500 comprises the fingerprinting module 508, a side channel response may be observed as a result of the fingerprinting module 508 being activated by the instruction. Where a device being tested does not comprise such a fingerprinting module 508, the instruction may not result in an expected side channel response being provided by the device under test.

In some examples the fingerprinting module 508 may comprise a fingerprinting structure. A fingerprinting structure may be example of an element of the microarchitecture designed to represent a provenance of the apparatus 500. The fingerprinting module 508 may or may not provide, contribute to or affect an intended overall functionality of the apparatus 500. Rather, in some examples, the fingerprinting module 508 may contribute to a fingerprinting function and may not affect another, main or ‘useful’ function of the apparatus 500.

In some examples, a component of the apparatus 500 may be designed to implement the fingerprinting structure. The component may be designed to be independent from the ‘useful’ circuitry of the apparatus 500 (i.e., corresponding to the main or ‘useful’ functionality of the apparatus 500) and to be activated for the fingerprinting process itself (for example in an application specific integrated circuit (ASIC), a processor or any other kind of hardware architecture). By providing the fingerprinting structure (which may in some examples be more costly to implement by a manufacturer of an unauthorized computing device), a check may be performed as to whether or not a device under test implements the fingerprinting structure (e.g., to facilitate determination of the provenance of the device under test).

In some examples, the component designed to implement the fingerprinting structure may be ‘entangled’ (e.g., embedded or otherwise integrated) with the microarchitecture. For example, the fingerprinting structure may at least one of: modulate the strength of the side channel response (e.g., leakage); affect the evolution of the state of the microarchitecture; be activated when the component is in a specified mode dedicated to its fingerprinting function.

In some examples, a fingerprinting structure may change dynamically if implemented on reprogrammable hardware, e.g., using an FPGA or other reprogrammable device. By observing how the fingerprinting structure changes or reacts to the instruction, a determination may be made as to the provenance of the apparatus 500.

In some examples, any of the modules described above (e.g., the receiving module 404, sensor 504, reprogrammable module 506 and/or fingerprinting module 508) may comprise at least one dedicated processor (e.g., an application specific integrated circuit (ASIC) and/or field programmable gate array (FPGA), etc) for implementing the functionality of the module.

In some examples, the module (e.g., the receiving module 404, sensor 504, reprogrammable module 506 and/or fingerprinting module 508) may comprise at least one processor for implementing instructions which cause the at least one processor to implement the functionality of the module described above. In such examples, the instructions may be stored in a machine-readable medium (not shown) accessible to the at least one processor. In some examples, the module itself comprises the machine-readable medium. In some examples, the machine-readable medium may be separate to the module itself (e.g., the at least one processor of the module may be provided in communication with the machine readable medium to access the instructions stored therein).

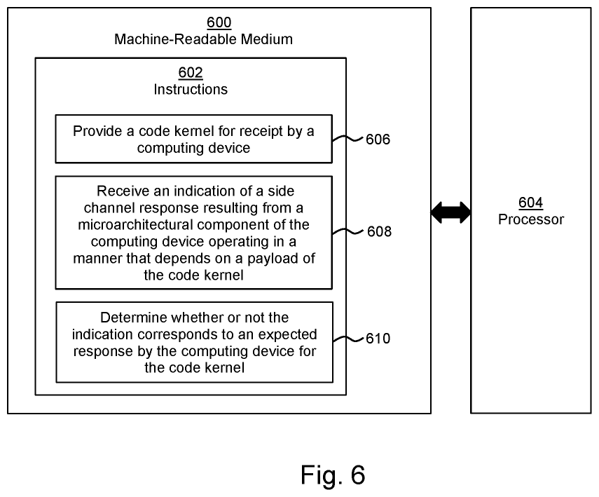

FIG. 6 schematically illustrates a machine-readable medium 600 (e.g., a tangible machine-readable medium) which stores instructions 602, which when executed by at least one processor 604, cause the at least one processor 604 to carry out certain example methods described herein (e.g., the method 100 or 300).

In this example, the instructions 602 comprises instructions 606 to cause the at least one processor 604 to provide a code kernel for receipt by a computing device. The instructions 602 further comprises instructions 608 to cause the at least one processor 604 to receive an indication of a side channel response resulting from a microarchitectural component of the computing device operating in a manner that depends on a payload of the code kernel. The instructions 602 further comprise instructions 610 to cause the at least one processor 604 to determine whether or not the indication corresponds to an expected response by the computing device for the code kernel.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional modules of the processing circuitry 210 and the apparatus 400, 500 (for example, the receiving module 404, sensor 504, reprogrammable module 506, fingerprinting module 508) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
providing a computing device with an instruction to cause the computing device to execute the instruction;
monitoring a side channel of a microarchitectural component of the computing device to obtain an indication of whether or not a state of the microarchitectural component changes as a result of the computing device executing the instruction; and
determining, using processing circuitry, whether or not the indication corresponds to an expected state of the microarchitectural component for the instruction.

2. The method of claim 1, where the instruction comprises a code kernel to cause an expected change in state of the microarchitectural component that depends on a design of the microarchitectural component.

3. The method of claim 2, comprising providing the computing device with an additional instruction to cause the computing device to execute the additional instruction, where the additional instruction comprises a different code kernel expected to have a different effect on the state of the microarchitectural component for the design of the microarchitectural component, so that execution of the instruction and the additional instruction provides the indication.

4. The method of claim 1, where monitoring the side channel comprises acquiring, from a probe, a characteristic of the side channel that depends on activity of the computing device, where the probe comprises at least one of: a hardware probe and a software probe.

5. The method of claim 4, where the characteristic comprises at least one of: a power consumption of the computing device; an electromagnetic signal; a spatial profile of the electromagnetic signal; an optical signal; heat generated by the computing device; an execution time for the instruction; a cache status of the computing device; an arithmetic logic unit congestion status; a software-derived fingerprint indicative of the activity; a hardware-derived fingerprint indicative of the activity.

6. The method of claim 4, comprising obtaining the indication by monitoring a plurality of side channels and aggregating the characteristic acquired from the plurality of side channels.

7. The method of claim 1, comprising determining whether or not the indication obtained from the computing device corresponds to an expected indication for a specified computing device, where the specified computing device is one of: an authorized computing device; or a non-authorized computing device.

8. The method of claim 1, comprising monitoring a side channel of another component, where the computing device and the other component are communicatively coupled to each other, to determine whether or not the execution of the instruction causes an expected change in state in the other component.

9. The method of claim 1, comprising controlling the computing device to cause the computing device to operate in a specified mode, and monitoring the side channel to determine whether or not the indication is as expected for the computing device operating in the specified mode, where operating the computing device in the specified mode comprises at least one of:
causing the computing device to operate out of specification; and
identifying a valid operating value, within specification, and causing the computing device to operate according to the valid operating value.

10. The method of claim 1, where determining whether or not the indication corresponds to the expected state of the microarchitectural component for the instruction comprises identifying whether or not an evolution of the indication over a period of time is at least one of: probabilistic and deterministic.

11. Apparatus comprising processing circuitry, the processing circuitry comprising:
a receiving module to receive an instruction to cause a microarchitectural component of the processing circuitry to operate in a specified manner, where a side channel of the apparatus is to provide an indication of whether or not the microarchitectural component operates in the specified manner as a result of the processing circuitry implementing the instruction.

12. The apparatus of claim 11, further comprising a sensor to monitor a side channel of the apparatus, where the sensor is to obtain the indication and cause the indication to be sent to a trusted environment.

13. The apparatus of claim 11, further comprising a reprogrammable module comprising the microarchitectural component.

14. The apparatus of claim 11, further comprising a fingerprinting module to cause the microarchitectural component to operate in the specified manner, where the fingerprinting module is to be activated in response to receiving the instruction.

15. A tangible machine-readable medium storing instructions which, when executed by at least one processor, cause the at least one processor to:
provide a code kernel for receipt by a computing device;
receive an indication of a side channel response resulting from a microarchitectural component of the computing device operating in a manner that depends on a payload of the code kernel; and
determine whether or not the indication corresponds to an expected response by the computing device for the code kernel.
